(19) United States
(12) Patent Application Publication
(10) Pub. No.: US 2024/0040163 A1
(43) Pub. Date: Feb. 1, 2024

(54) EXPERIENCE SHARING SYSTEM

(71) Applicant: Charles Isgar, Scottsdale, AZ (US)

(72) Inventor: Charles Isgar, Scottsdale, AZ (US)

(21) Appl. No.: 18/485,023

(22) Filed: Oct. 11, 2023

Related U.S. Application Data
(63) Continuation of application No. 17/201,902, filed on Mar. 15, 2021.
(60) Provisional application No. 63/061,654, filed on Aug. 5, 2020.

(51) Int. Cl. H04N 21/2187; H04N 21/414; G06F 3/14; G06F 3/0482

(52) U.S. Cl. CPC H04N 21/2187; H04N 21/41407; G06F 3/1454; G06F 3/0482

(57) ABSTRACT

Described is a personal experience sharing system for sharing personal experiences in the form of audio, visual, or audio and visual media. The system may include a server having a memory storing personal experience information, a first user computing device coupled to the server, and a second user computing device coupled to the server. The system operates to provide a means for a user to stream his or her personal experiences and for other users to view or share in the streamed personal experiences. This may be done anonymously and may not require the parties to know each other.

### CROSS REFERENCE TO RELATED APPLICATION[S]

This application is a continuation of U.S. patent application entitled “EXPERIENCE SHARING SYSTEM,” Ser. No. 17/201,902, filed Mar. 15, 2021, which claims priority to U.S. Provisional Patent Application entitled “EXPERIENCE SHARING SYSTEM,” Ser. No. 63/061,654, filed Aug. 5, 2020, the disclosures of which are hereby incorporated entirely herein by reference.

### BACKGROUND OF THE INVENTION

### Technical Field

This invention generally relates to a system for sharing experiences, and more specifically to an organized system for sharing personal experiences, perspectives and the like with others in the form of audio, visual or audio and visual media allowing others to virtually tag along in shared experiences utilizing the system.

### State of the Art

With social media usage increasing and common for almost all technology users, individuals have a desire to share their experiences and to see what others are experiencing. These experiences are posted within a social media platform and are viewable by others. Most commonly, they are viewable by those who one is already associated with. For platforms that allow for streaming of content, they are only viewable live by those who know that one is going live. There lacks a system that allows for anonymous and other means for sharing one's experience or sharing in the experiences of others where there is consistently live content to share in.

Accordingly, what is needed is an organized system for sharing personal experiences in the form of audio, visual or audio and visual media.

### SUMMARY OF THE INVENTION

An embodiment includes a personal experience sharing system comprising: a server having a memory storing experience information; a first user computing device coupled to the server; and a second user computing device coupled to the server, wherein the server is programmed to: receive and process a signal that the first user computing device has accessed the system and is requesting to share personal experiences for others to share in; receive live streaming content from the first user computing device and store the same in the memory of the server as personal experience information; receive and process a signal that the second user computing device has accessed the system and is searching for personal experiences to share in; send, for display on the second user computing device, the personal experience information including available personal experiences to share in; receive and process a selection from the second user computing device of one of the available personal experiences to share in corresponding to the live streaming content from the first user computing device; and automatically send the live streaming content from the first user computing device for display on the second user computing device.

The personal experiences may be in a form of visual media. The personal experiences may be in a form of audio media. The personal experiences may be in a form of visual and audio media. The first user computing device may be a mobile computing device. A mobile application may operate on the first user computing device. The mobile application operating on the first user computing device may comprise a user interface having a list of types of the personal experiences to stream. The second user computing device may be a mobile computing device. A mobile application may operate on the second user computing device. The live streaming content from the first user computing device for display on the second user computing device may be sent anonymously. The first user computing device may be stationary during the live streaming. The first user computing device may be mobile during the live streaming. The live streaming content from the first user computing device for display on the second user computing device may be simultaneously automatically sent to additional user computing devices.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a diagrammatic view of a personal experience sharing system according to an embodiment;

FIG. 2A is a user interface for interaction with a personal experience sharing system by a user sharing his or her experience according to an embodiment;

FIG. 2B is a user interface for interaction with a personal experience sharing system by a user sharing his or her experience according to an embodiment;

FIG. 2C is a user interface for interaction with a personal experience sharing system by a user sharing his or her experience according to an embodiment;

FIG. 2D is a user interface for interaction with a personal experience sharing system by a user sharing his or her experience according to an embodiment;

FIG. 3A is a user interface for interaction with a personal experience sharing system by a user seeking to share another's experience according to an embodiment;

FIG. 3B is a user interface for interaction with a personal experience sharing system by a user seeking to share another's experience according to an embodiment;

FIG. 3C is a user interface for interaction with a personal experience sharing system by a user seeking to share another's experience according to an embodiment;

FIG. 3D is a user interface for interaction with a personal experience sharing system by a user seeking to share another's experience according to an embodiment;

FIG. 4 is a user interface for interaction with a personal experience sharing system according to an embodiment;

FIG. 5 is a user interface for interaction with a personal experience sharing system according to an embodiment;

FIG. 6 is a user interface for interaction with a personal experience sharing system according to an embodiment;

FIG. 7 is a user interface for interaction with a personal experience sharing system according to an embodiment;

FIG. 8 is a user interface for interaction with a personal experience sharing system according to an embodiment;

FIG. 9 is a user interface for interaction with a personal experience sharing system according to an embodiment;

FIG. 10 is a user interface for interaction with a personal experience sharing system according to an embodiment;

FIG. 11A is a user interface for interaction with a personal experience sharing system according to an embodiment;

FIG. 11B is a user interface for interaction with a personal experience sharing system according to an embodiment;

FIG. 12 is a user interface for interaction with a personal experience sharing system according to an embodiment;

FIG. 13 is a user interface for interaction with a personal experience sharing system according to an embodiment; and

FIG. 14 is a user interface for interaction with a personal experience sharing system according to an embodiment.

### DETAILED DESCRIPTION OF EMBODIMENTS OF THE INVENTION

Embodiments of the present invention relate to an organized system for sharing personal experiences in the form of audio, visual or audio and visual media allowing others to obtain vicarious experiences utilizing the system. The system may include the use of a mobile application operating on a user computing device that may be a mobile computing device like a smartphone, a tablet, a wearable, and the like; and/or the system may operate on any type of computing device as a downloadable application or even as a web application.

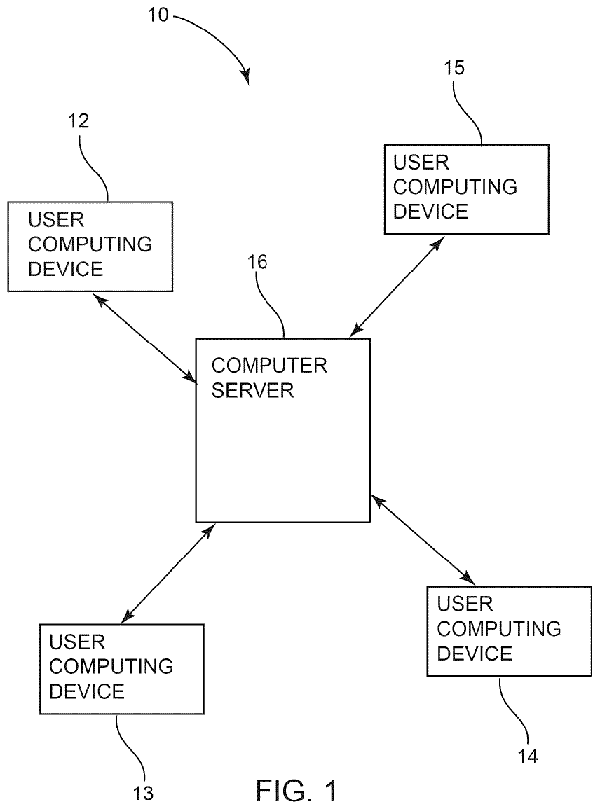

FIG. 1 depicts an embodiment of a personal experience sharing system 10. The system 10 may include user computing devices 12, 13, 14, and 15 and a server 16, wherein each user computing device 12, 13, 14, and 15 is coupled to the computer server 16. This coupling may be a network connection, such as a wireless connection through an Internet connection, a Wi-Fi connection, a Bluetooth connection or the like, wherein the user computing devices 12, 13, 14, and 15 may communicate with and receive communication from the server 14. Each user computing device 12, 13, 14, and 15 may be any of a desktop computer, a laptop, a tablet, a smartphone, a wearable device and the like. The server 14, in some embodiments, may be a computer server or a cloud-based infrastructure architecture.

The server 14 may include a memory storing personal experience information. The personal experience information may include live streaming content of users' personal experiences, and the like. The live streaming content may be audio, visual or audio and visual.

A first user computing device 12 and a second user computing device 13 may each be coupled to the server 16, and the server 16 may be programmed to receive and process a signal that the first user computing device has accessed the system and is requesting to share personal experiences for others to share in; receive live streaming content from the first user computing device and store the same in the memory of the server as personal experience information; receive and process a signal that the second user computing device has accessed the system and is searching for personal experiences to share in; send, for display on the second user computing device, the personal experience information including available personal experiences to share in; receive and process a selection from the second user computing device of one of the available personal experiences to share in corresponding to the live streaming content from the first user computing device; and automatically send the live streaming content from the first user computing device for display on the second user computing device.

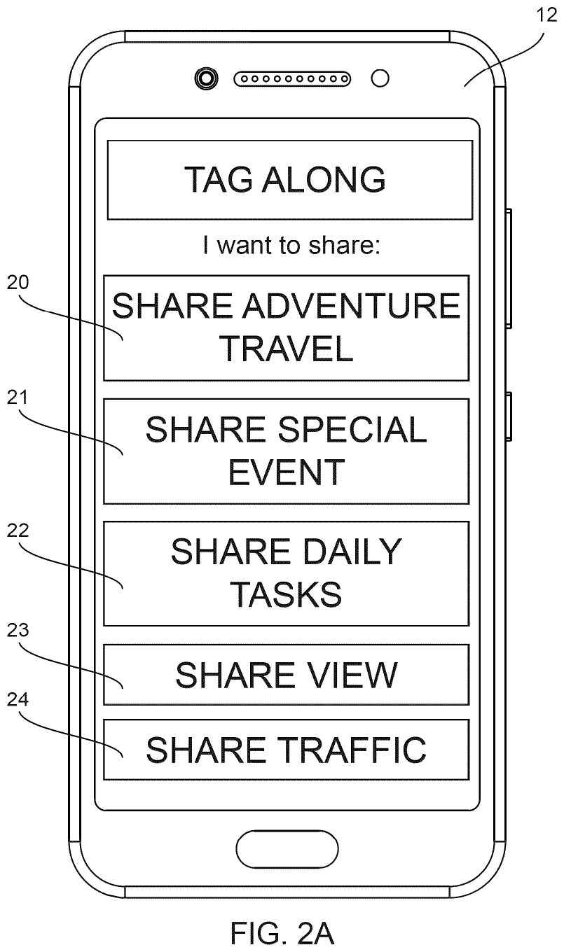

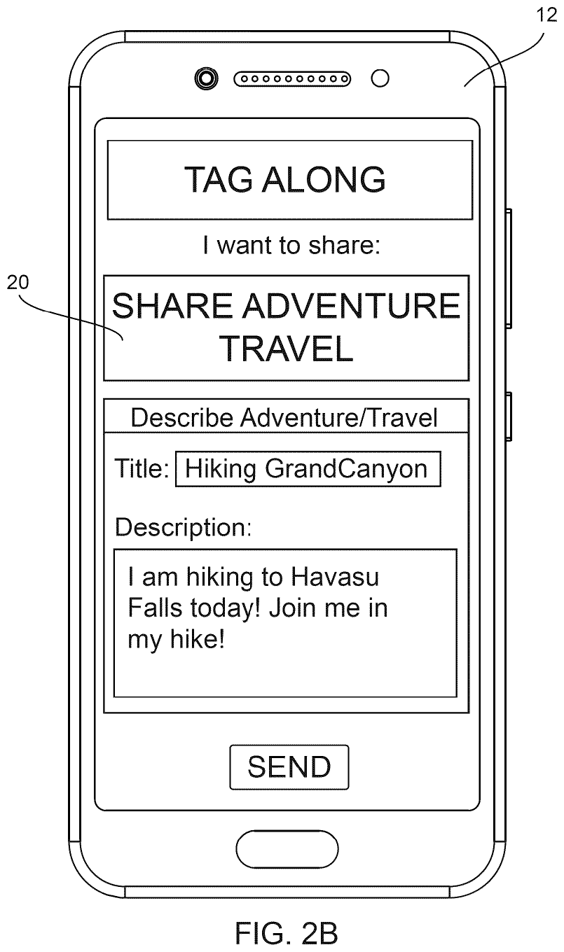

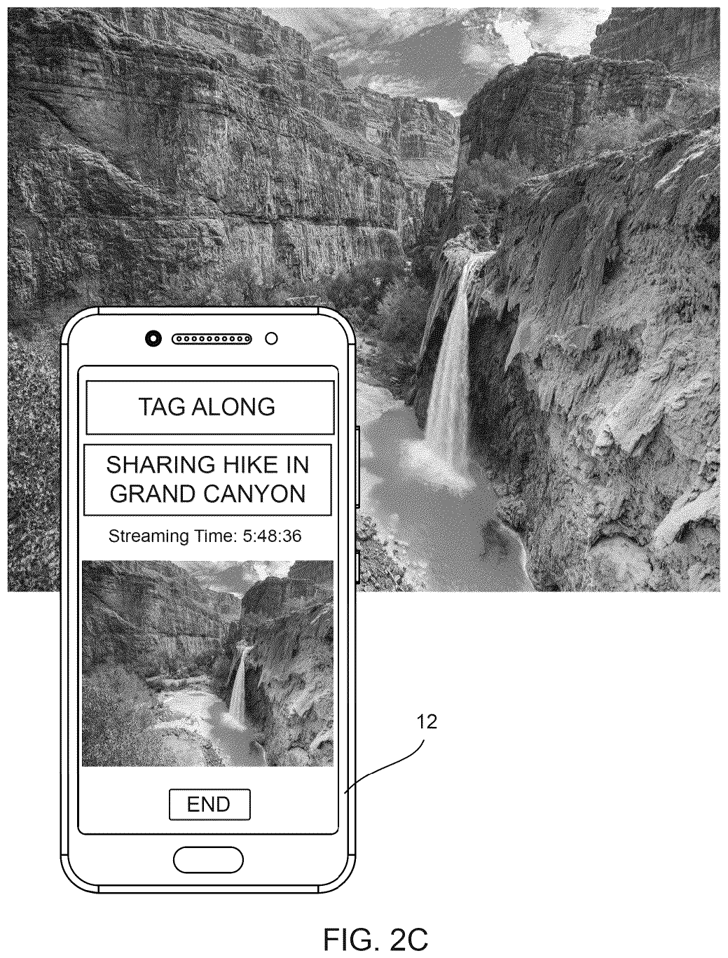

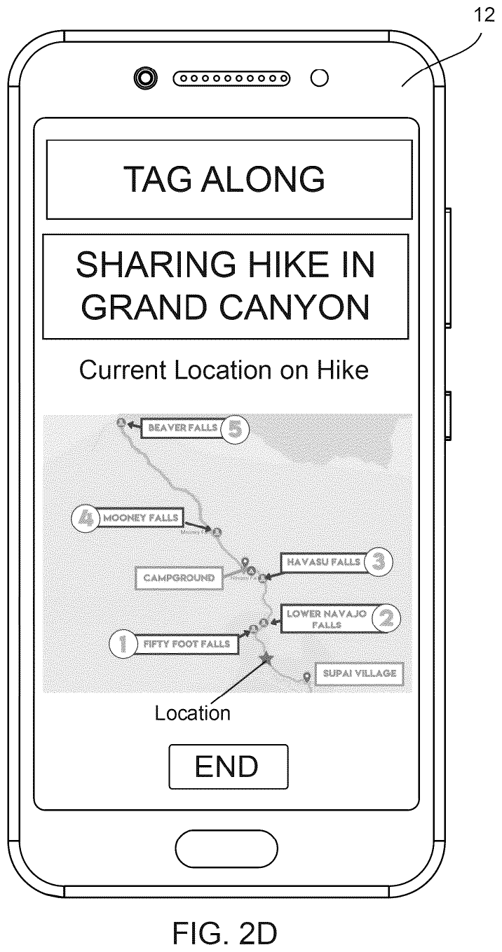

Referring to FIGS. 2A-2D, the system 10 may include a first user computing device 12 that is in a form of a smartphone operating a mobile app. The mobile app operating on the first user computing device 12 may include a user interface with a list of possible types of content to stream, as shown in FIG. 2A. For example, without limitation, the user interface may include streaming content such as share adventure travel 20, share special event 21, share daily tasks 22, share view 23, and share traffic 24). The user may select one of the content types and begin streaming, such as Share Adventure Travel 20. The server 16 may be programmed to send for display, on the first user computing device 12, a user interface for entering data regarding the experience to share, as shown in FIG. 2B. The user may enter details, such as the title of the experience and a description of the same, like Hiking Grand Canyon and corresponding description. The streaming content may be sent to the server 16 and stored in the memory of the server 16 as personal experience information as shown in FIG. 2C. This storing may be a buffering of live content in order to provide live content to other user devices that seek to share in the personal experience streamed from the first computing device 12. Additionally, in some embodiments, as shown in FIG. 2D, the user may share his or her location while on the experience, such as by depicting the location on a map. This allows those viewing the experience an opportunity to see the progress and join the streamed shared experience at desired locations along the experience.

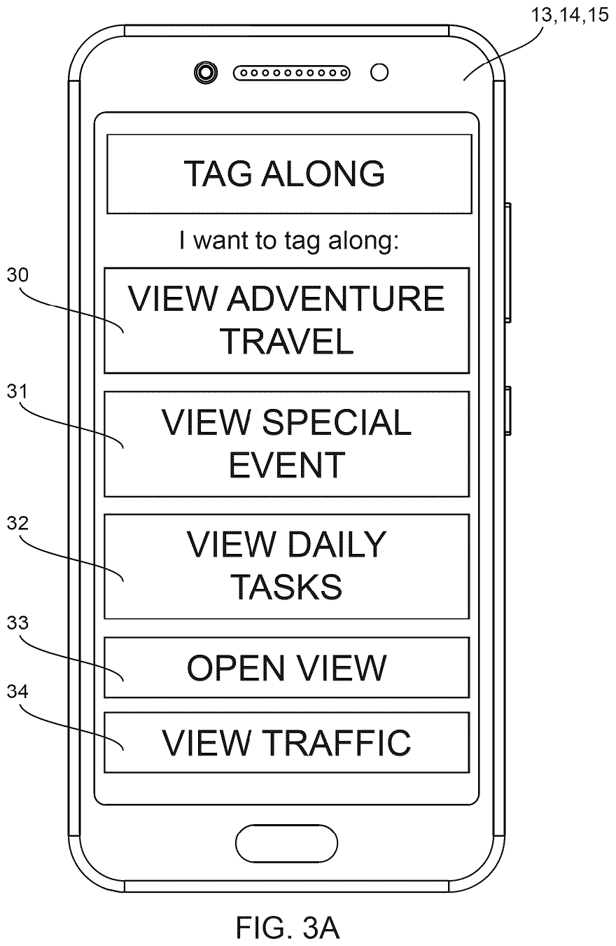

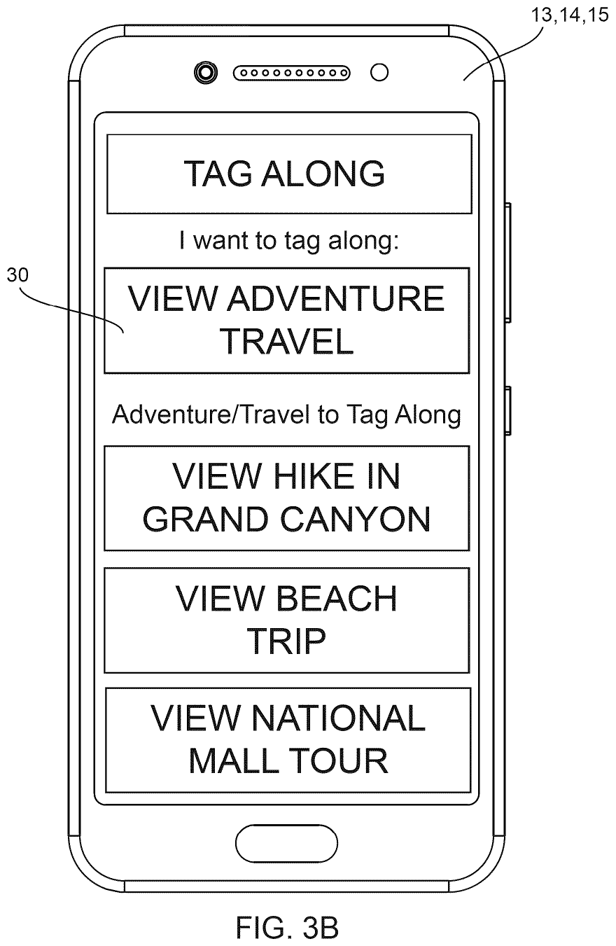

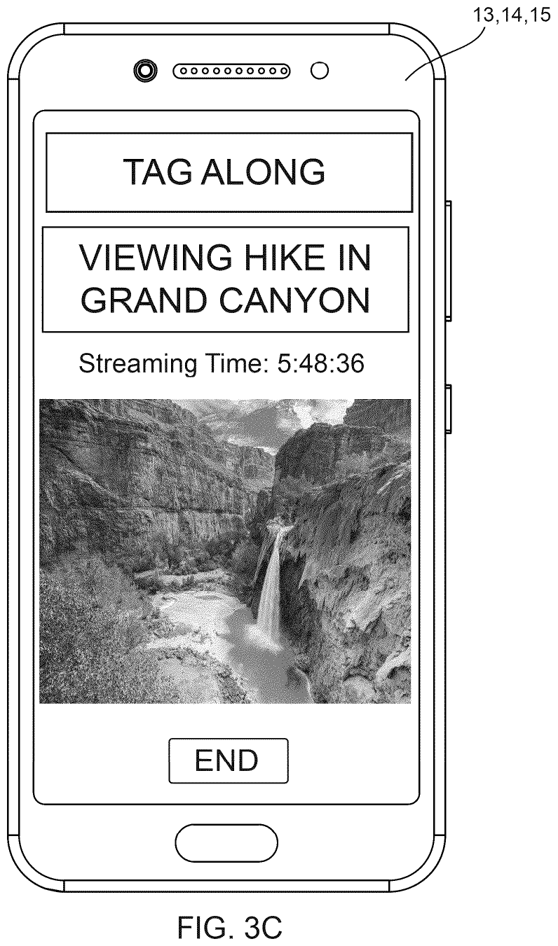

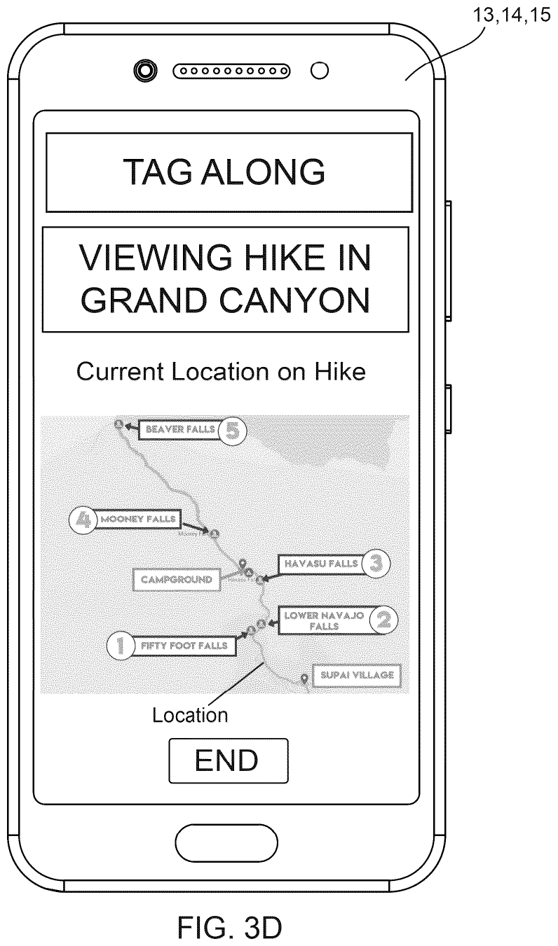

Referring to FIGS. 3A-3D, the system 10 may include a second user computing device 13, 14, 15 that is in a form of a smartphone operating a mobile app. The mobile app operating on the second user computing device 13, 14, 15 may include a user interface with a list of possible types of personal experiences to share in, as shown in FIG. 3A. For example, without limitation, the user interface may include types of personal experiences such as (suggest change to: view adventure travel 30, view special event 31, view daily tasks 32, open view 33, and view traffic 34). The server 16 may be programmed to send for display, on the second user computing device 13, 14, 15, a user interface for selecting the type of experience to share, as shown in FIG. 3B. The user may select one of the personal experience types and will be directed to a user interface, such as that shown in FIG. 3C to begin sharing in the streaming content. The personal experience selected may be sent to the second user computing device 13, 14, 15 for engaging with. Additionally, in some embodiments, as shown in FIG. 3D, the user sharing his or her experience may also share his or her location while on the experience, such as depicting the location on a map. This allows those viewing the experience an opportunity to see the progress and join the streamed shared experience at desired locations along the experience.

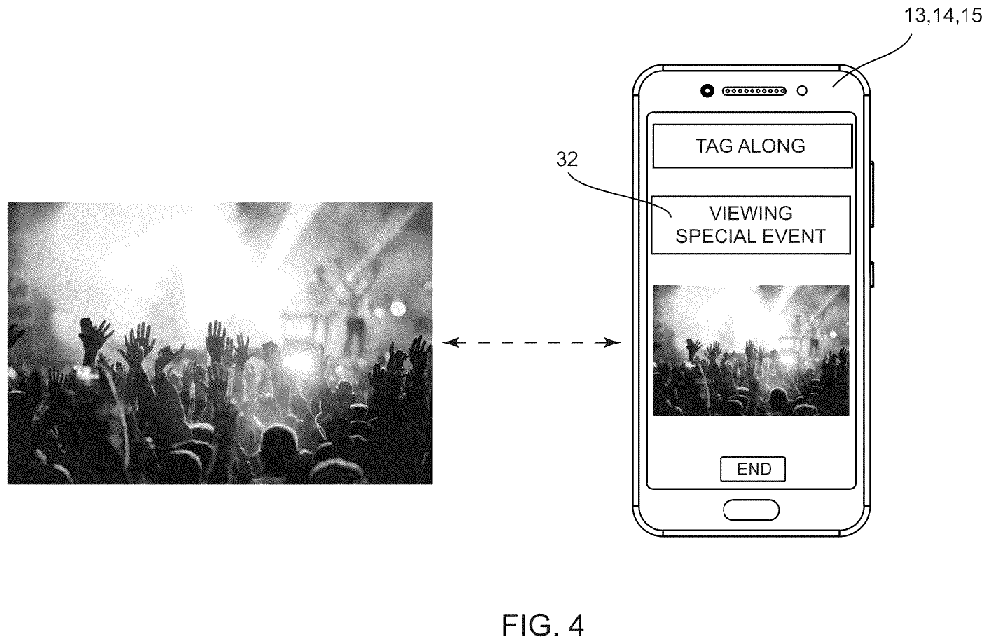

Once a type of personal experience has been selected, the system 10 operates to send the content to the second user computing device 13, 14, 15, as depicted in FIGS. 4-14. Additionally, it will be understood that many different users may join and view the same experience simultaneously. In some instances, the system may include a private setting where friends or other associated individuals may utilize the system to vicariously share in an experience of one of the members of the private friend group. Further still, the system may include embodiments that allow for use of the system anonymously and other users may provide their user information or portions thereof to others using the system. Additionally, a user may be an influencer that can establish a following of many different users that seek to see and experience what the influencer does from the influencer's perspective.

As shown in FIG. 4, the second user device 13, 14, 15 may select to view special event 31, allowing the second user computing device 13, 14, 15 to view video/image on the screen and/or project audio through the speaker of the second user computing device 13, 14, 15. As shown in FIG. 4, the second user computing device 13, 14, 15 may depict the special event personal experience that may be a view such as a concert.

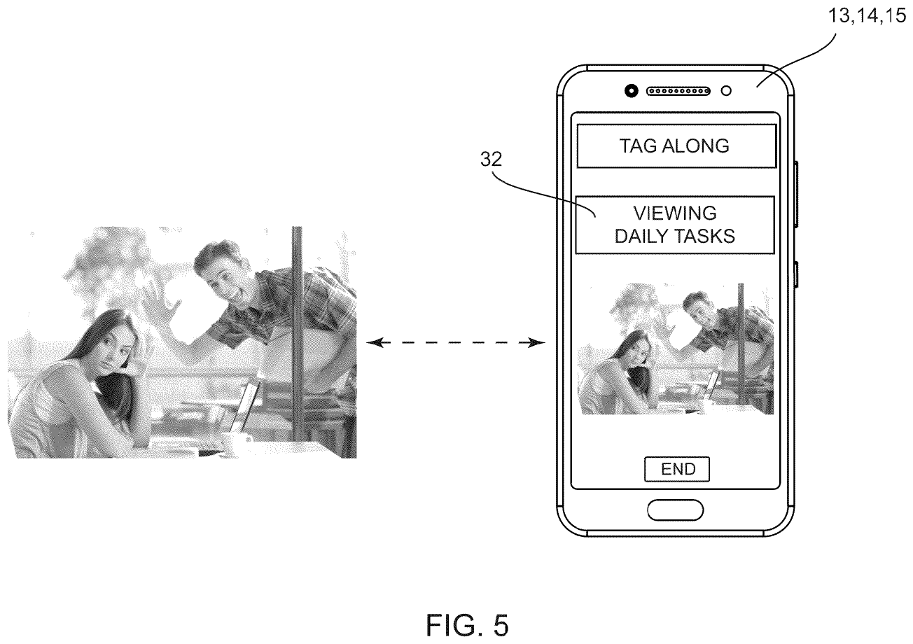

As shown in FIG. 5, the second user device 13, 14, 15 may select to view daily tasks 32, allowing the second user computing device 13, 14, 15 to view video/image on the screen and/or project audio through the speaker of the second user computing device 13, 14, 15. For example, the user may share in the personal experiences of daily tasks including a user's daily world, doing task, cooking, engagement in conversation with others, etc. This may further operate to share the user's location, neighborhood, sights and sounds including window. It may share the user's daily commute, car, bike and so forth to other things like other daily activities, going to GYM, school, farmers' market, news and entertainment events, demonstrations, etc.

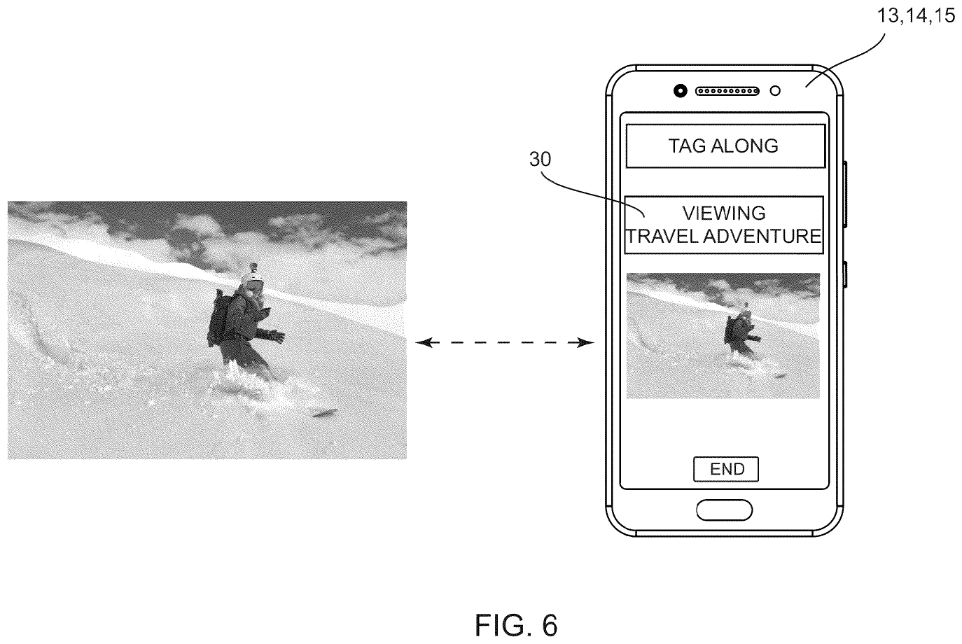

As shown in FIG. 6, the second user device 13, 14, 15 may select to view a travel adventure 30, allowing the second user computing device 13, 14, 15 to view video/image on the screen and/or project audio through the speaker of the second user computing device 13, 14, 15. For example, FIG. 6 depicts a travel adventure personal experience that is a snowboarding experience allowing the sharing of the video/image and/or audio associated with that.

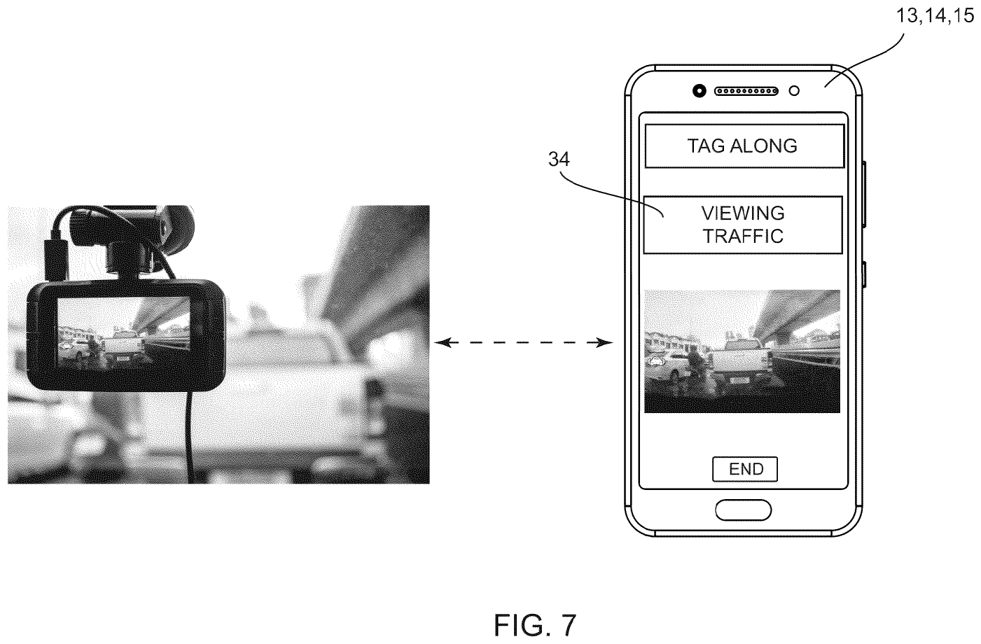

As shown in FIG. 7, the second user device 13, 14, 15 may select to view traffic 34, allowing the second user computing device 13, 14, 15 to view video/image on the screen and/or project audio through the speaker of the second user computing device 13, 14, 15. For example, FIG. 7 depicts a traffic personal experience allowing the sharing of the video/image and/or audio associated with the current traffic in a user selected area.

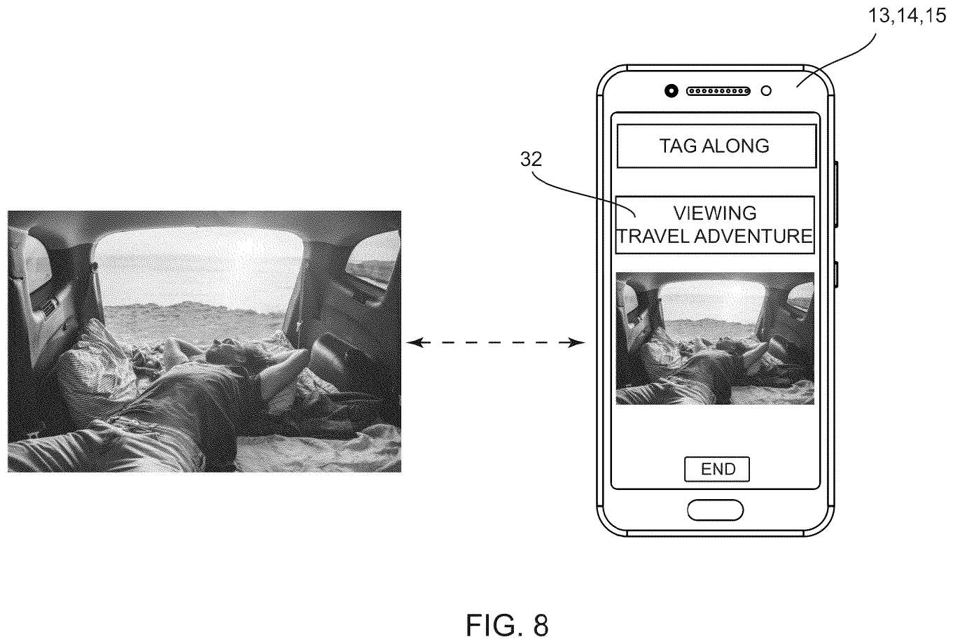

As shown in FIG. 8, the second user device 13, 14, 15 may select to view a travel adventure 30, allowing the second user computing device 13, 14, 15 to view video/image on the screen and/or project audio through the speaker of the second user computing device 13, 14, 15. For example, FIG. 8 depicts a travel adventure personal experience that is a beach trip experience allowing the sharing of the video/image and/or audio associated with that.

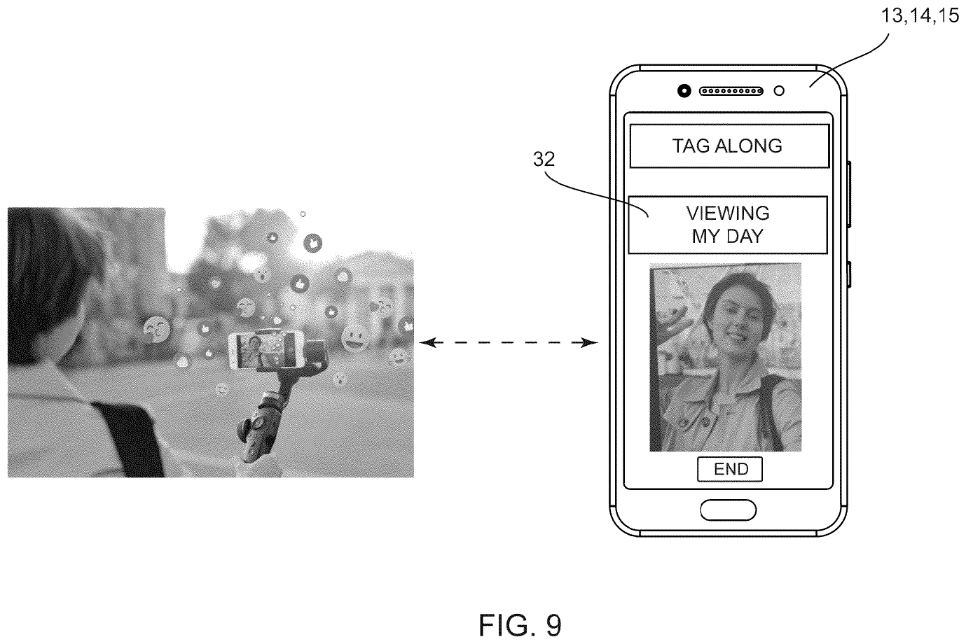

As shown in FIG. 9, the second user device 13, 14, 15 may select to view an individual's day as a form of daily task 32, allowing the second user computing device 13, 14, 15 to view video/image on the screen and/or project audio through the speaker of the second user computing device 13, 14, 15. For example, FIG. 9 depicts a personal experience that is a person's day experience allowing the sharing of the video/image and/or audio associated with that.

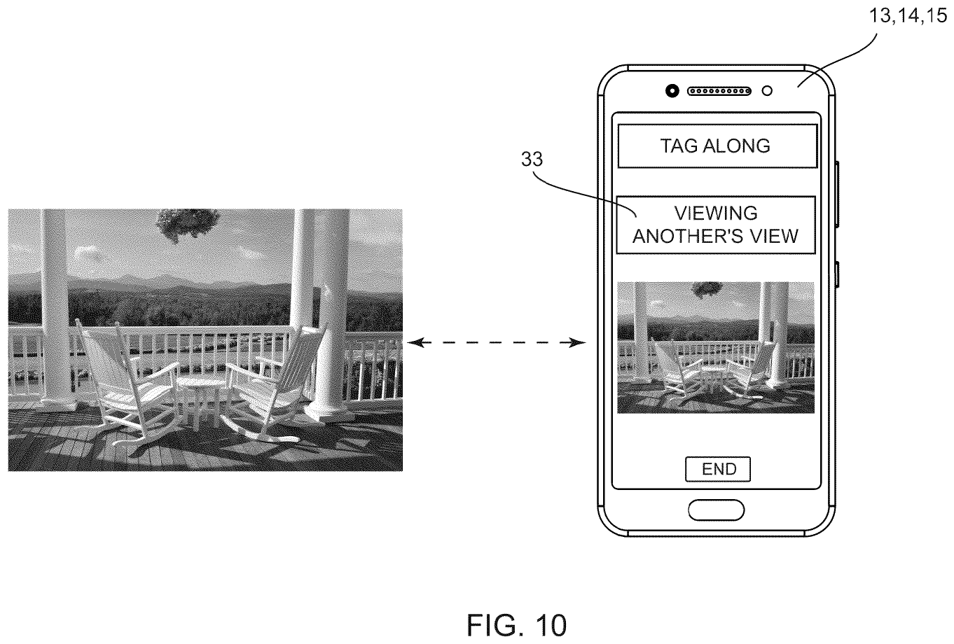

As shown in FIG. 10, the second user device 13, 14, 15 may select to share in another's view 33, allowing the second user computing device 13, 14, 15 to view video/image on the screen and/or project audio through the speaker of the second user computing device 13, 14, 15. As shown in FIG. 10, that may be a view such as a scenic view.

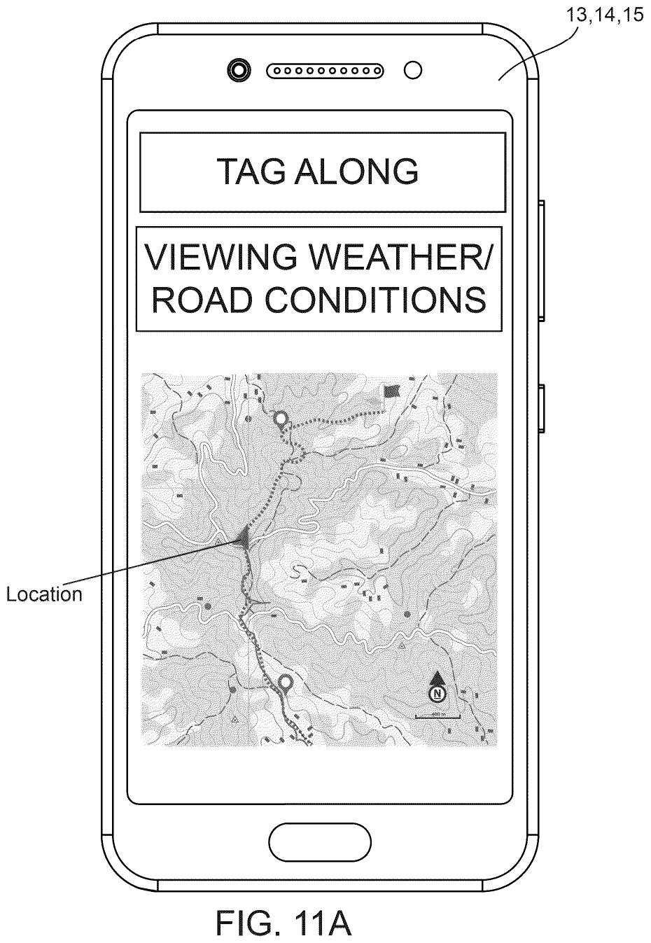

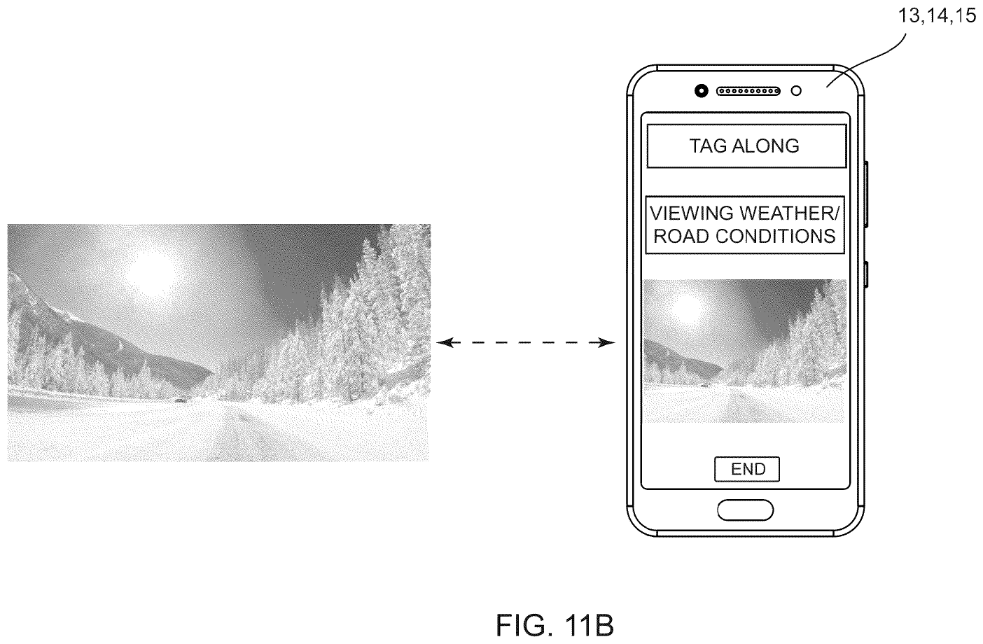

As shown in FIGS. 11A-11B, the second user device 13, 14, 15 may select to share in weather or road conditions personal experience, allowing the second user computing device 13, 14, 15 to view video/image on the screen and/or project audio through the speaker of the second user computing device 13, 14, 15. The system as shown in FIG. 11A may include a map view that a user may be travelling or plans on travelling soon and wishes to see the weather or road conditions further ahead of his or her current location or may wish to see weather or road conditions on a certain part of the road prior to travelling. The user may select the location and another user sharing the weather/road condition experience in that location and be directed to a user interface as shown in FIG. 11B that displays the weather/road condition. As an example, FIG. 11B depicts a weather/road condition personal experience that is a snow weather/icy roads road condition experience allowing the sharing of the video/image and/or audio associated with that.

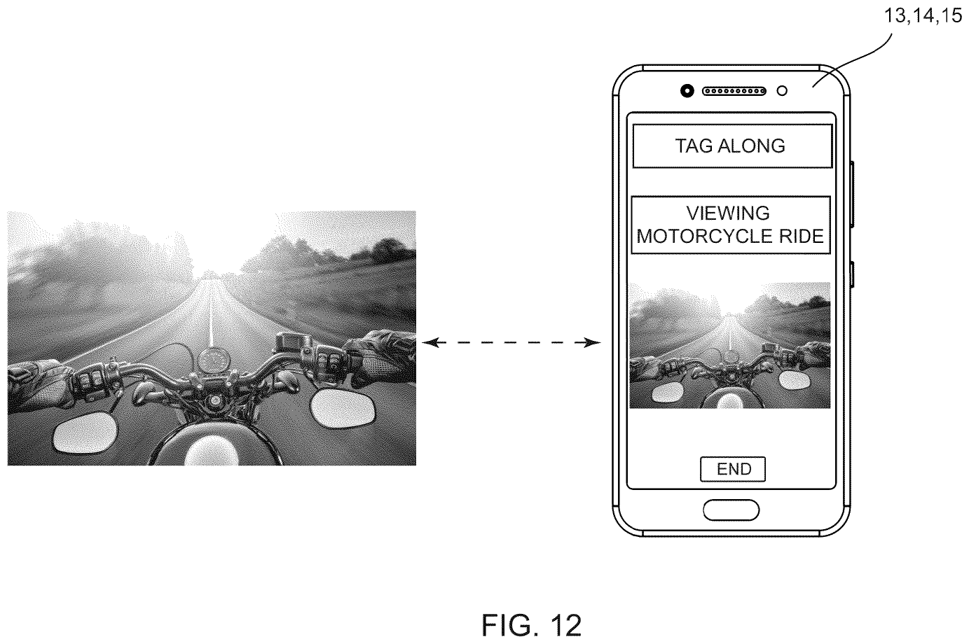

As shown in FIG. 12, the second user device 13, 14, 15 may select to share in a motorcycle ride personal experience, allowing the second user computing device 13, 14, 15 to view video/image on the screen and/or project audio through the speaker of the second user computing device 13, 14, 15. As shown in FIG. 12, depicted is a motorcycle ride personal experience that is an experience from a view of the rider on a motorcycle allowing the sharing of the video/image and/or audio associated with that.

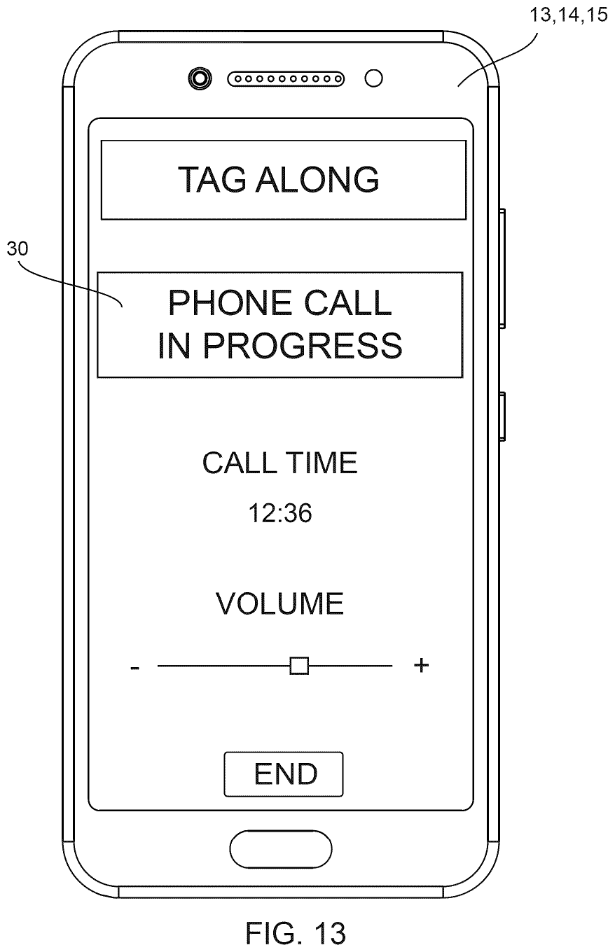

As shown in FIG. 13, the second user device 13, 14, 15 may select to view public event or gathering, allowing the second user computing device 13, 14, 15 to view video/image on the screen and/or project audio through the speaker of the second user computing device 13, 14, 15. As shown in FIG. 13, the second user computing device 13, 14, 15 may depict the public event or gathering personal experience that may be a view such as a parade. Other public events or gatherings may include inaugurations, protests, rallies, and the like.

As shown in FIG. 14, the second user device 13, 14, 15 may select to listen to a phone call 30, allowing the second user computing device 13, 14, 15 to project through the speaker of the second user computing device 13, 14, 15. In some embodiments, the system 10 may allow people to get discounted phone service to allow others to listen in on their calls while protecting anonymity during the day for entertainment. Such a system may also include viewing text message exchanges. Certain channels may feature different people in different life situations with different backgrounds. Channels may include Celebrity, New to America, Teenagers, Political conversations, Cajun fisherman, and so forth.

While the system 10 is depicted in the figures with the above topics or types of personal experiences, the system 10 may include several types of content. For example, the categories of interest may include: adventure travel; road reports, such as clicking on a snowy road or traffic of someone with cam; a view from house, deck, window, etc.; a view in a house with people doing things; a view in car with people; a view external of car of people doing things; someone cooking at home; a different neighborhood experience, such as, but not limited to a Beverly Hills person, the south side of Chicago, riding along with a lowrider, etc.; big events, parades, etc.; small events, weddings, etc.; and the like.

As will be understood, the system 10 may be a paid platform for general browsing, a hired platform, for specific tagalongs, or a hired platform to get a person to scout trips or destinations for you. For example, tag along with a college student to check out a particular college campus while the user is making a college decision.

The system allows more than one person can click on a particular experience to share in. In such instances, a group of friends could join in a trip to the wine country, or the like. The system 10 may allow those seeking to share in the experience know the travelers rating, camera, and per minute fee if applicable, and if the personal experiences will provide audio, narration and the like.

The system is a rich digital eco system that lets a user know where people on the system are (stationary or moving) and allows a user to click on that person to, for example, tag along going up to Grand Canyon, go to big concert, ride a train through the Rockies, or the like travel adventure.

Additionally, some embodiments depicted in the figures include use of a mobile camera, such as on a mobile phone. It will be understood that in some embodiments, the camera may be a fixed camera or a camera in a fixed location. Further still, the system 10 may archive videos, images, audio and the like for other purposes such review if necessary or may be recorded at the selection of the user sharing his or her experience.

Embodiments may be available on or through the internet, such as through domain names reserved and owned by Applicant that include tagalong-now.com, tagalonview.com, tagalongcam.com, tagalonghub.com, tagalong.club, tagalong.live, welcometomyworld.live, vicariousthrill.com, piggybackworld.com, piggybackusa.com or the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A personal experience sharing system comprising:
a server having a memory storing experience information;
a first user computing device coupled to the server; and
a second user computing device coupled to the server, wherein the server is programmed to:
receive and process a signal that the first user computing device has accessed the system and is requesting to share personal experiences for others to share in;
receive live streaming content from the first user computing device and store the same in the memory of the server as personal experience information;
receive and process a signal that the second user computing device has accessed the system and is searching for personal experiences to share in;
send, for display on the second user computing device, the personal experience information including available types of personal experiences to share in, wherein the available types of personal experiences comprise two or more of view adventure travel, view special event, view daily tasks, open view, and view traffic;
receive and process a selection from the second user computing device of one of the available types of personal experiences to share in and send, display on the second user computing device available streams corresponding to the selected available types of personal experiences to share in;
automatically send a map for display on the second user computing device depicting a location of the first user computing device shared by the first user computing device in response to selection of an available stream corresponding to the live streaming content of the first user computing device, wherein the location of the first user computing device is updated from time to time; and
automatically send the live streaming content from the first user computing device for display on the second user computing device, in response to the second user computing device selecting to join the live stream at desired location along the one of the available personal experiences as depicted on the map.

2. The personal experience sharing system of claim 1, wherein the personal experiences are in a form of visual media.

3. The personal experience sharing system of claim 1, wherein the personal experiences are in a form of audio media.

4. The personal experience sharing system of claim 1, wherein the personal experiences are in a form of visual and audio media.

5. The personal experience sharing system of claim 1, wherein the first user computing device is a mobile computing device.

6. The personal experience sharing system of claim 5, wherein a mobile application operates on the first user computing device.

7. The personal experience sharing system of claim 6, wherein the mobile application operating on the first user computing device comprises a user interface having a list of types of the personal experiences to stream.

8. The personal experience sharing system of claim 1, wherein the second user computing device is a mobile computing device.

9. The personal experience sharing system of claim 8, wherein a mobile application operates on the second user computing device.

10. The personal experience sharing system of claim 1, wherein the live streaming content from the first user computing device for display on the second user computing device is sent anonymously.

11. The personal experience sharing system of claim 1, wherein the first user computing device is stationary during the live streaming.

12. The personal experience sharing system of claim 1, wherein the first user computing device is mobile during the live streaming.

13. The personal experience sharing system of claim 1, wherein the live streaming content from the first user computing device for display on the second user computing device is simultaneously automatically sent to additional user computing devices.
